(19) United States
(12) Patent Application Publication
(10) Pub. No.: US 2007/0156633 A1
(43) Pub. Date: Jul. 5, 2007

(54) Creation and browsing of content objects

(76) Inventor: Takayuki Sugita, Tokyo (JP)

Correspondence Address: LAW OFFICES OF MICHAEL DRYJA, 704 228TH AVENUE NE, PMB 694, SAMMAMISH, WA, 98074, US

(21) Appl. No.: 11/323,418

(22) Filed: Dec. 31, 2005

(51) Int. Cl. G06F 17/30

(52) U.S. Cl. 707/1

(57) ABSTRACT

Context objects are created and browsed. A computerized system includes a database, a log database, a log database analysis mechanism, and a context object-creation mechanism. The database is for storing content objects and context objects. Each context object represents a relationship between a first content object and a second content object. The log database is to store information regarding the content objects browsed by users within browsing sessions. The log database analysis mechanism is for analyzing the log database for browsing between each pair of content objects, in order to generate statistics regarding the browsing from a first content object of each pair to a second content object of the pair. The context object-creation mechanism then creates the objects based on the statistics generated by the log database analysis mechanism.

### FIELD OF THE INVENTION

The present invention relates generally to context objects, where each context object representing a relationship from a first content object to a second content object, and more particularly to the creation and browsing of such context objects.

### BACKGROUND OF THE INVENTION

Content management systems have become a popular way for users to obtain access to data. A content management system is simply a system in which there are stored content objects, which can be searched and browsed by a user, such as by using a web browser or another type of a computer program. A given content object in general stores content, such as business data, a word processing document, and so on. Some content management systems are private, in that only users affiliated with a given organization, such as a company, can access them. Other content management systems are public, such that any type of user can access them. Examples of public content management systems include search engines on the Internet, for instance, in which a given content object represents a web page. The Internet itself may be considered a content management system as well.

A difficulty with content management systems is the continuing problem of users being unable to effectively and quickly obtain the information and knowledge that they are seeking. Some types of content management systems define links between content objects, such as, for instance, a hyperlink between two web pages. However, the search engines for or of such content management systems do not actually manage these links. For instance, content management systems commonly do not manage the type of content from which a given content object has been referred, or the type of content to which a given object refers.

However, from the standpoint of a user, it is common to acquire new knowledge and information not by reviewing just a single content object, but instead by referencing multiple content objects that are correlated in some way. For example, a user may find content that has information that they are looking for by using a keyword search within a search engine to find some desired content objects, and then carry out another, different keyword search, to locate further content objects. From the perspective of the user, the content objects revealed in the first search, and selected by the user, and the content objects revealed in the second search, and also selected by the user, are related. However, this “relatedness” or dependence information is not captured within the content management system itself, insofar as, for instance, the search engine or other tool that is being used cannot search the correlation or relationship between a first content object found in a first search, and a second content object found in a second search.

In the Japanese published patent application no. JP-A-2003-28118, a technique to effectively manage the dependence between content objects is disclosed. However, this technique requires that a creating user manually register the dependence, or relationship, between content objects. This technique is therefore essentially unusable, since it would require significant effort to manually create the dependences among content objects. Furthermore, the relationships between content objects are defined from the perspective of a creating user. However, what is important is not the relationships between content objects that the creating user may see or understand, but rather the relationship between content objects that the browsing, viewing, or reading end user sees or understands. As a result, the relationships defined in accordance with this technique may even if undertaken prove to be less than useful.

In the Japanese published patent application no. JP-A-2003-150422, such dependence or relationship information between content objects is stored in a database. However, the information must still be manually created, and further the relationships between content objects are defined from the point of view of a creating user, which is undesirable. Furthermore, the dependence or relationship information is not combinable with the content objects themselves, and thus cannot be browsed for or searched as the content objects themselves can be.

Finally, in the Japanese published patent application no. JP-A-2004-426710, dependence or relationship information is automatically generated, without user intervention, but again this information is created from the point of view of a creating user, which is undesirable. Here, too, the dependence or relationship information is not combinable with the content objects themselves, and thus cannot be browsed for or searched as the content objects themselves can be.

For these and other reasons, therefore, there is a need for the present invention.

### SUMMARY OF THE INVENTION

The present invention relates generally to the creation and browsing of context objects. A method of one embodiment of the invention is implemented with a computer. Context objects are created. Each context object represents a relationship from a first content object to a second content object. The context objects are stored within a database in which content objects themselves are also stored. A user is permitted to simultaneously browse the content objects and the context objects stored within the database, such as by searching using keywords, or by another approach.

A computerized system of an embodiment of the invention includes a database, a log database, a log database analysis mechanism, and a context object-creation mechanism. The database is for storing content objects and context objects. Each context object represents a relationship between a first content object and a second content object. The log database is to store information regarding the content objects browsed by users within browsing sessions. The log database analysis mechanism is for analyzing the log database for browsing between each pair of content objects, in order to generate statistics regarding the browsing from a first content object of each pair to a second content object of the pair. The context object-creation mechanism then creates the objects based on the statistics generated by the log database analysis mechanism.

Finally, an article of manufacture of an embodiment of the invention includes a tangible computer-readable medium, and means in the medium. The computer-readable medium may be a recordable data storage medium, or another type of tangible medium. The means is for creating context objects. Each context object represents a relationship from a first content object to a second content object. The means is further for permitting a user to simultaneously browse content objects and the context objects.

Embodiments of the invention provide for advantages over the prior art. The invention automatically creates, and can also automatically update, context objects, based on content objects that may be modified over time. The invention manages the life cycle of a context object, insofar as deletion of an included content object causes the context object to be archived. Importantly, the context objects can be browsed and searched by users no different than the content objects themselves can be. Similarly, context objects can be displayed in the same way as content objects are. For instance, the relationship between content objects of a context object may be depicted in a bidirectional manner, where the degree of relatedness between the content objects in each direction is further depicted. The invention may also not display content objects of context objects that are restricted to the user in question.

Still other advantages, aspects, and embodiments of the invention will become apparent by reading the detailed description that follows, and by referring to the accompanying drawings.

### DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of a method, according to a preferred embodiment of the invention, and is suggested for printing on the first page of the patent.

FIG. 2 is a diagram depicting an environment in which a content management system (CMS) is operable, according to an embodiment of the invention.

FIG. 3 is a flowchart of a method for creating a context object, according to an embodiment of the invention.

FIG. 4 is a flowchart of a method for browsing a context object, according to an embodiment of the invention.

FIG. 5 is a diagram of a representative display of a number of content objects and a number of context objects, according to an embodiment of the invention.

FIG. 6 is a flowchart of a method for updating a context object, according to an embodiment of the invention.

FIG. 7 is a flowchart of a method for archiving a context object, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Overview

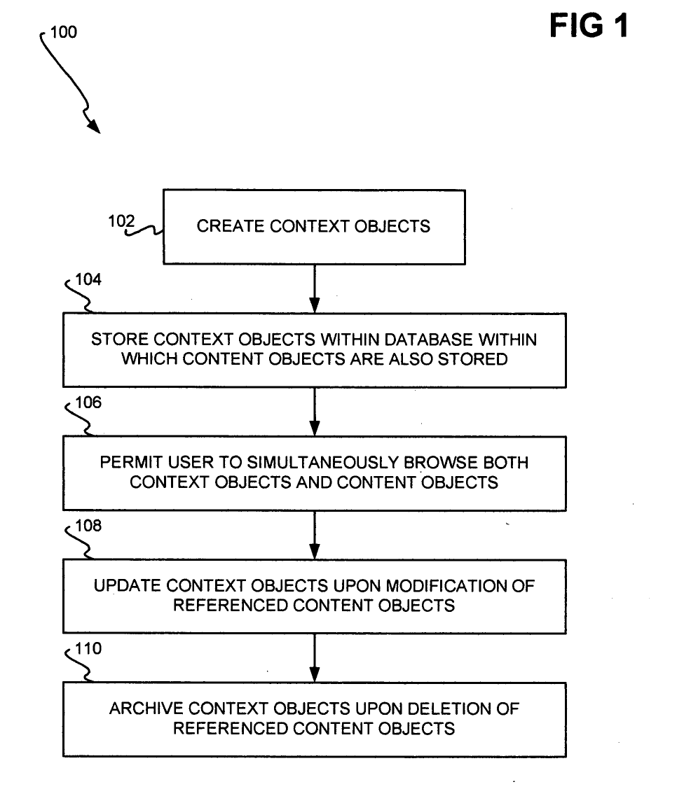

FIG. 1 shows a method 100, according to an embodiment of the invention. Like the other methods of embodiments of the invention, the method 100 may be implemented as one or more computer programs stored on a computer-readable medium. Various parts of the method 100 are described in more detail in subsequent sections of the detailed description, and can be performed by various parts of a system that is described in a subsequent section of the detailed description.

Context objects are created (102). A context object is data that represents a relationship from a first content object to a second content object, and also optionally from the second content object back to the first content object. An object is a term that is used herein in a generic sense, and refers to any type of data structure intended to store data. A content object is data that represents content, and may be electronic documents, files, web pages, and so on.

Thus, a context object expresses the relationship or dependence between two content objects. A reading, viewing, or browsing end user who browses to a first content object, and then browses to a second content object, effectively defines such a relationship or dependence from the first content object to the second content object, which can be encapsulated within a context object. A user may immediately browse from the first content object to the second content object, such that he or she performs no other tasks in-between, and such that it can be said that there is a relationship from the first content object to the second content object. If the user had started from the second content object and then browsed to the first content object, then it is said that there is a relationship from the second content object to the first content object as well.

Alternatively, a user may perform a search or another task to locate the first content object, and then perform a search or another task to locate the second content object, such that it can be said that there is a relationship from the first content object to the second content object. In this sense, after having browsed to the first content object, the content object that the user browses immediately to next is the second content object, even though the user has performed another task—such as another search—in-between the browsing. In general, then, a context object defines a relationship from a first content object to a second content object, and optionally also from the second content object back to the first content object.

This relationship is defined by the end user, during viewing or browsing of the content objects. The relationship, in other words, is not defined by a creating user who may have created some of the content objects, nor is it defined by an administrative user or other user who manages the content management system of the content objects themselves. Rather, in the process of browsing content objects, end users automatically and implicitly cause the creation of context objects, by virtue of how they browse these content objects—i.e., in what order they browse the content objects. Particular embodiments of context object creation are described in subsequent sections of the detailed description.

The context objects are stored within the same database in which the content objects are also stored (104). To this end, the context objects are like content objects in that they are browsable, viewable, and searchable by the user. That is, the context objects may be stored in such a way as to permit such browsing, viewing, and searching by the user, no different than content objects. The context objects are not, in other words, stored in a database apart from the content objects, where the context objects cannot be easily retrieved and utilized.

A user is thus permitted to simultaneously browse both context objects and content objects (106). Browsing in this sense means that a user is able to access both context objects and content objects in a variety of different ways. For instance, a user may be permitted to perform keyword searches. Besides displaying content objects that match the entered keywords, the context objects that encompass these content objects may also be displayed to the user. As a result, the user is able to leverage the past relationships among content objects that other users (or the same user) have previously created. Permitting a user to browse context objects while at the same time browsing content objects is powerful, insofar as it leverages these defined relationships.

Furthermore, in one embodiment, when content objects are modified, the context objects that reference such modified content objects are updated (108). A particular embodiment of how this updating occurs is described in a subsequent section of the detailed description. Such updating ensures that the context objects are not out-of-date, and thus reflect the fact that their constituent or encompassed content objects have also been updated, or modified.

Finally, in one embodiment, when a given content object is deleted, any context objects that reference this deleted object is archived (110). Archiving may mean at a minimum that the user no longer is permitted to view the context objects in question when browsing the context and content objects, since the user is not able to view the constituent content objects of these context objects, which have been deleted: Thus, the context objects may be archived in the sense that they are stored in such a way so that the user is no longer able to browse them, or they may even be deleted as well.

Technical Background (System)

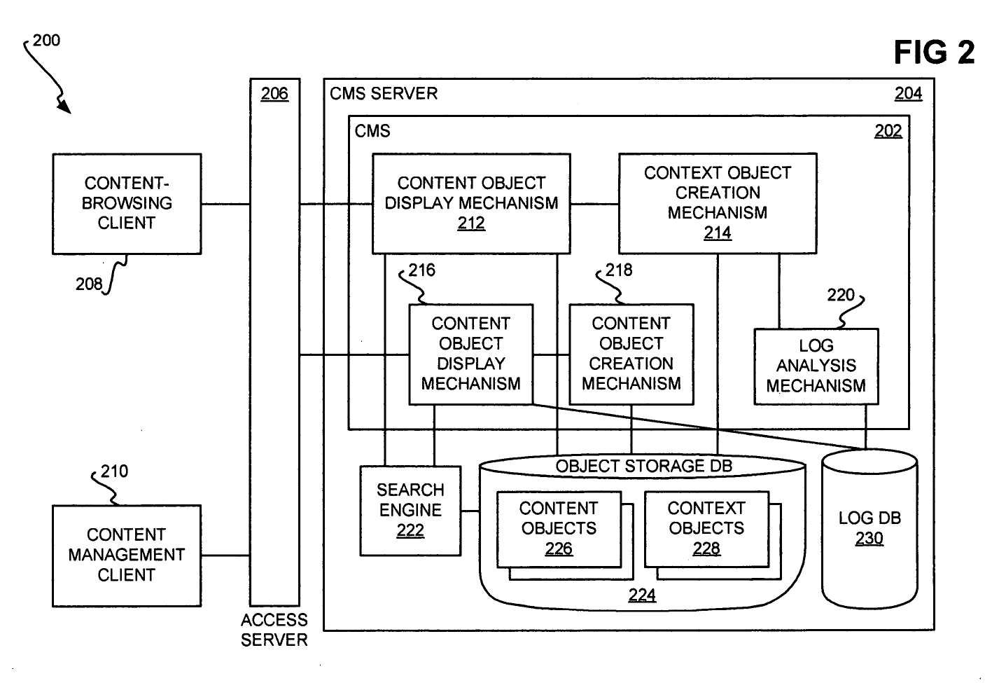

FIG. 2 shows a representative operating environment 200, including a content management system (CMS) 202, according to an embodiment of the invention. The operating environment 200 is specifically made up of a CMS server 204 that hosts the CMS 202, as well as an access server 206, a content-browsing client 208, and a content management client 210. As can be appreciated by those of ordinary skill within the art, other environments in which the CMS 202 is operable can also be implemented in accordance with other embodiments of the invention. Each of the servers 204 and 206 and the clients 208 and 210 may in one embodiment by a computing device, as can also be appreciated by those of ordinary skill within the art.

Besides hosting the CMS 202, the CMS server 204 includes a search engine 222, an object storage database 224 storing content objects 226 and context objects 228, and a log database 230. The CMS 202 is made up of a context object display mechanism 212, a context object creation mechanism 214, a content object display mechanism 216, a content object display mechanism 216, and a log analysis mechanism 220. Each of these mechanisms 212, 214, 216, 218, and 220 may be implemented in software, hardware, or a combination of software and hardware.

The context object display mechanism 212 allows for selected context objects 228 within the database 224 to be displayed, whereas the context object creation mechanism 214 creates the context objects 228 and stores them within the database 224, as is described in more detail in subsequent sections of the detailed description. Likewise, the content object display mechanism 216 allows for selected content objects 226 within the database 224 to be displayed, whereas the content object creation mechanism 218 creates the content objects 226 and stores them within the database 224. Content object display and creation are performed within embodiments as the invention as is conventionally accomplished with content, as can be appreciated by those of ordinary skill within the art. For instance, users may create content objects and store them within the database 224, and the creation mechanism 218 may index them as appropriate.

The log analysis mechanism 220 analyzes browsing logs stored in the log database 230. The browsing logs indicate the content objects browsed by a user, when they were browsed, and in what order they were browsed. As such, the log analysis mechanism 220 determines scores between pairs of content objects, where if such scores exceed a given threshold, a context object defining the relationship between the content objects of a given pair is created. This is described in more detail in a later section of the detailed description. The log analysis mechanism 220 can thus be considered as determining when or if a context object should be created between two given content objects, by assessing the relationship between the two content objects as evidenced by the browsing logs stored in the database 230.

Finally, the search engine 222 allows for both the content objects 226 and the context objects 228 to be searched, and thus effectively browsed. Searching may be accomplished by using keywords, as is conventional. Furthermore, the context objects 228 are stored in the database 224 in such a way to permit the search engine 222 to search them essentially no different than it searches the content objects 226. In one embodiment, for instance, an entered keyword or keywords are searched against all the content objects 226. For each content object in which these keywords are found, any context objects 228 that reference this content object is also considered as including the keywords, and displayed as part of the search results.

The CMS server 204 is accessed by users of the clients 208 and 210 via an access server 206. The access server 206 may be indeed considered more than one server, providing functionality such as user management, user authentication, load balancing, and so on. The difference between the clients 208 and 210 is that the former can only view and browse, such as via keyword searches, the content objects 226 and the context objects 228 stored in the database 224. By comparison, the content management client 210 can also modify the content objects 226, which can result in the updating of the context objects 228. It is noted that that the context objects 228 themselves are not directly modifiable, but only updated in one embodiment where a referenced content object has been modified, as is described in more detail later in the detailed description.

Thus, a user of the content-browsing client 208 or the content management client 210 accesses the CMS server 204 via the access server 206. It may enter in keywords to be searched, such that the search engine 222 performs this functionality. The resulting list of context objects and content objects is displayed to the user. If the user selects one of the context objects for viewing, the context object display mechanism 212 displays it, whereas if the user selects one of the content objects for viewing, the content object display mechanism 216 views it. The process of browsing by the user results in the creation of a log, stored within the database 230. Periodically, the log analysis mechanism 220 analyzes the log, and guides the context object creation mechanism 214 to create or update context objects as appropriate. Thus, users of the clients 208 and 210 are able to browse both the content objects 226 and the context objects 228.

Furthermore, a user of the content management client 210 may access the CMS server 204 via the access server 206 to perform additional functionality. In particular, such a user may create new content, via the content object creation mechanism 218, which in one embodiment can be accomplished by simply importing these content objects into the CMS 202, or importing just references to these content objects into the CMS 202. Furthermore, such a user may delete existing content objects, or modify existing content objects, which is also achieved via the content object creation mechanism 218.

Context Object Creation

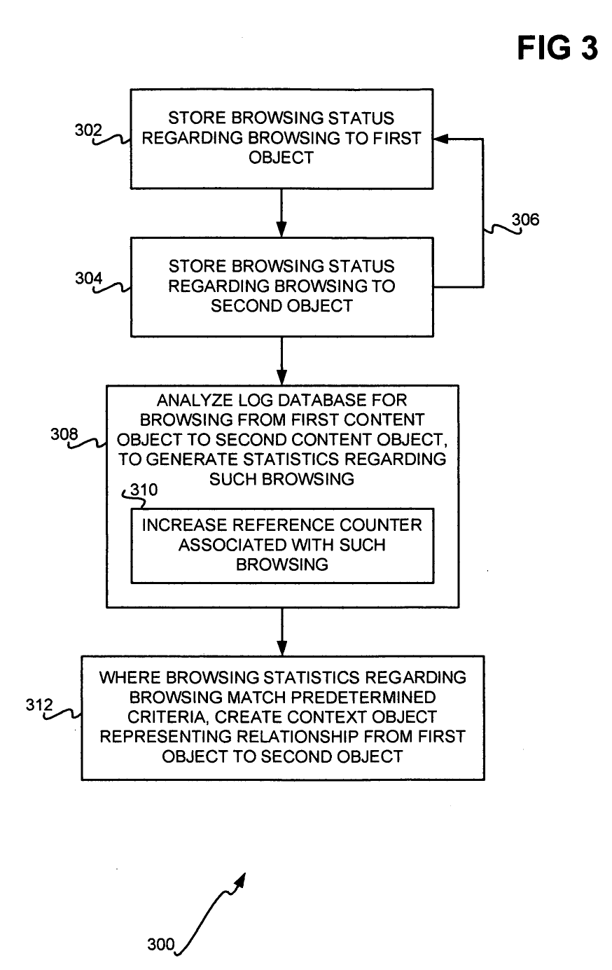

FIG. 3 shows a method 300 for creating a context object, according to an embodiment of the invention. The method 300 may be performed, for instance, to create each of the context objects created in part 102 of the method 100 of FIG. 1. The method 300 is particularly described in relation to the creation of a single context object, which represents the relationship between a first content object and a second content object. For instance, the relationship may be from the first content object to the second content object, and/or from the second content object back to the first content object.

First, parts 302 and 304 are repeated, as indicated by the arrow 306, for each of a number of users browsing the first and the second content objects. The browsing status regarding the browsing of a user to the first object is recorded within the log database (302). Likewise, the browsing status regarding the browsing of the user to the second object is recorded within the log database (304). The browsing status information recorded in the log includes the identity of the user who browsed to these objects, and the dates and times at which such browsing took place. Therefore, the browsing status information inherently includes information as to the order in which these content objects were browsed to, such that it is apparent that the second content object was browsed to after the first content object was browsed to. Parts 302 and 304 are performed in one embodiment by the content object display mechanism 216 of FIG. 2, by virtue of displaying (i.e., the results of browsing) these content objects by the user.

Next, the log database is analyzed in particular for this pair of content objects, including the first content and the second content object (308). That is, the log database is analyzed in particular for browsing to the first content object followed by browsing to the second content object, where no content object was browsed in-between. The log database is particularly analyzed periodically, for each unique pair of content objects. Analysis may further be accomplished from the second content object of each pair to the first content object of the pair, in addition to from the first object to the second object, in order to construct a given context object defining the relationship between this pair of content objects.

Analysis of the log database realizes the generation of statistics regarding browsing between the first content object and the second content object. In one embodiment, such statistics includes a reference counter, which is incremented, or increased, each time it is found within any log stored within the log database that the second content object has been browsed after the first content object has been browsed (or vice-versa), without any intermediary content object being browsed. This reference counter thus tracks the number of times the second content object was browsed to after the first content object was browsed to (and in one embodiment, vice-versa as well, either using the same or a different counter). In addition, in one embodiment, the most recent, or last, time the second content object was browsed to after the first content object was browsed to (and in one embodiment, vice-versa as well) is tracked.

Therefore, where the browsing statistics regarding the two content objects match or satisfy a predetermined criteria, a context object is created that represents or defines the relationship from the first object to the second object, and additionally in one embodiment the relationship from the second object to the first object (312). For instance, in one embodiment, where the reference counter exceeds a predetermined threshold, such as two or three, then a context object is created. The reference counter for just browsing from the first object to the second object may be considered, or the reference counters for browsing from the first object to the second object and for browsing from the second object to the first object may be considered, by adding them together, in evaluation against this threshold.

In another embodiment, a more sophisticated scoring approach is utilized to generate a score that dictates whether a context object is created or not. In particular, a calculated score is determined as follows:
score=num_{f→s}×func(last_{f→s})+num_{s→f}×func(last_{s→f}) (1)
In Equation (1), numf_{f→s} is the number of times the first content object was first browsed, and then the second content object was browsed (i.e., the second object was browsed from the first object). Likewise, numf_{f→s} is the number of times the second content object was first browsed, and then the first content object was browsed (i.e., the first object was browsed from the content object). last_{f→s} is the last, or most recent, time that the second object was browsed from the first object, as measured in hours or days before the log analysis is currently being performed in part 308 of the method 300. Similarly, last_{s→f} is the last, or most recent, time that the first object was browsed from the second object, as measured in hours or days before the long analysis is currently being performed in part 308.

The function func(·) generates a sliding importance factor, based on the last, or most recent, time in question, such that a higher factor or multiplier is generated if the last, or most recent, time is relatively recently (i.e., such as occurring merely hours ago), and a lower factor or multiplier is generated if the last, or most recent, time is relatively long ago (i.e., such as occurring days ago). In one embodiment, the function func(·) is the following:

$$func ( x ) = \sqrt{\frac{1}{x + 1}} \qquad ( 2 )$$

In Equation (2), x is measured in hours. Therefore, where the resulting score value score is greater than or equal to one, a corresponding context object encompassing the relationship between the first and the second content objects is created. In this embodiment, the context object defines both the relationship from the first object to the second object, as well as the relationship from the second object to the first object.

Thus, in embodiments of the invention, a content creating user creates or imports content objects into the content management system (CMS) 202 of FIG. 2, as is conventional. However, the CMS 202 automatically creates context objects from these content objects. This is accomplished such as by performing the method 300 of FIG. 3 that has been described.

In one embodiment, a context object may be stored in accordance with a data structure as is now described. First, the context object includes a title that represents, or denotes, the relationship between the first content object and the second content object in question. For instance, this title may be automatically generated, by concatenating the titles of the two content objects themselves, or in another manner. Next, the context object includes the identification of each of the first content object and the second object. In particular, the content object may identify these content objects by identifiers, such as guaranteed unique identifiers (GUID's), of the content objects. The content object may further store the title each of these content objects as well. The content object stores the number of times the first content object has referenced the second content object (i.e., the number of times the first content object was browsed after the second content object was browsed), and the number of times the second object has referenced the first object (i.e., the number of times the second object was browsed after the first object was browsed). These are the reference counters that have been described above.

The scores that have been described may also be stored in the context object itself In one embodiment, two particular scores are stored within the context object. First, a score representing the browsing from the first object to the second object is stored. Second, a score representing the browsing from the second object to the first object is stored. It is noted that this embodiment is different than Equation (1) that has been described above, because Equation (1) determines a single score that combines browsing from the first to the second object, and from the second to the first object. In this embodiment, the evaluation performed in Equation (1) to the left of the plus (+) sign is one score, and the evaluation performed in Equation (1) to the right of the plus (+) sign is another score, as can be appreciated by those of ordinary skill within the art. Furthermore, the score of Equation (1) may also be stored.

It is noted that the data structure may first be employed for each log stored within the log database 230 of FIG. 2. That is, what is referred to as simply context content may be created for each pair of content objects, by analyzing each different log, where a given log corresponds to the browsing history of a given user. Thereafter, these different context contents, or data structures, are combined together for similar such context contents, to form a combined context content group, which has been referred to herein as a context object. That is, for a given first content object and a given second content object, there may be multiple context contents created for multiple users that browsed from the first object to the second object, and/or vice-versa. Once all these different context contents have been created, they are then grouped together, such that the various corresponding counters of the different context contents are added together, and the various corresponding scores of the different context contents are added together, to yield a given context object for the first and the second content objects. Stated another way, in this embodiment, a context object may be created by first creating per-user context contents for the first and the second content objects, which are then combined into a single context object.

Browsing and Display of Context Objects

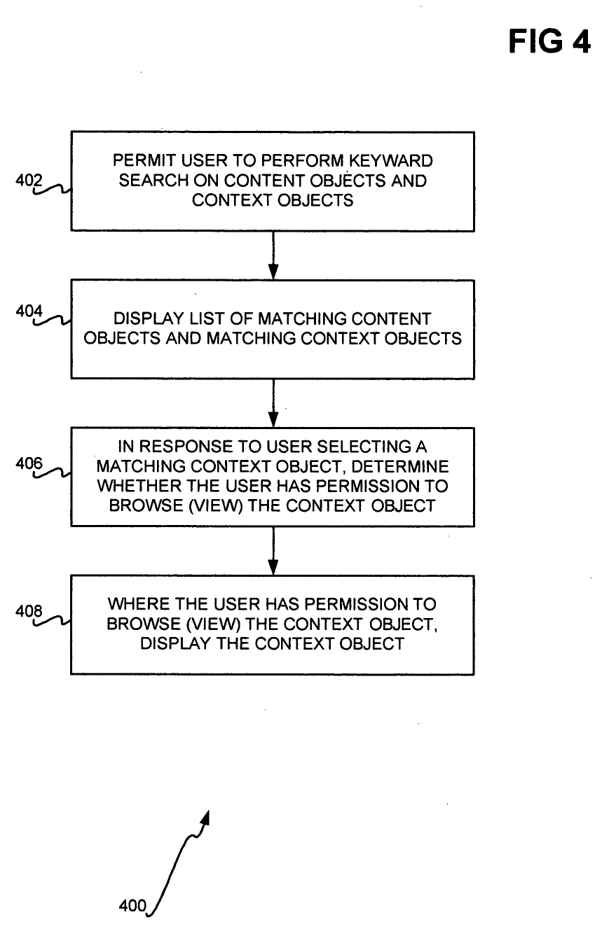

FIG. 4 shows a method 400 for browsing and displaying context objects, according to an embodiment of the invention. The method 400 may be performed by the search engine and the display mechanisms 212 and/or 216 of the content management system (CMS) 204 of FIG. 2, in conjunction with a user at the clients 208 and/or 210 of FIG. 2. A user is thus permitted to, for instance, perform keyword searches on content objects and context objects in unison (402). A user may enter the keywords on the clients 208 and/or 210, which is then sent to the search engine 222 through the access server 206 of FIG. 2. In response, the search engine 222 generates a list of matching content objects and context objects found in the database 224, which is sent back to the client in question, and display to the user (404).

A user can then at his or her client select a desired matching context object, in response to which, the context object display mechanism 212 determines whether the user has permission to browse, or view, the context object selected (406). For instance, the user may have to have permission or authorization to access both of the content objects referenced in a context object in order to access the context object. In this way, the CMS 204 maintains and extends previously accorded security clearances to users in relation to context objects, even if such security clearances were earlier defined only in relation to content objects. Where the user has such permission to browse or view the context object in question, the context object is sent from the display mechanism 212 (as retrieved from the database 224) through the server 206, to the client of the user for display thereat (408). However, it can be said, indeed, that the display mechanism 212 is that which actually displays the context object to the user. The permission determination may further be performed by the display mechanism 212.

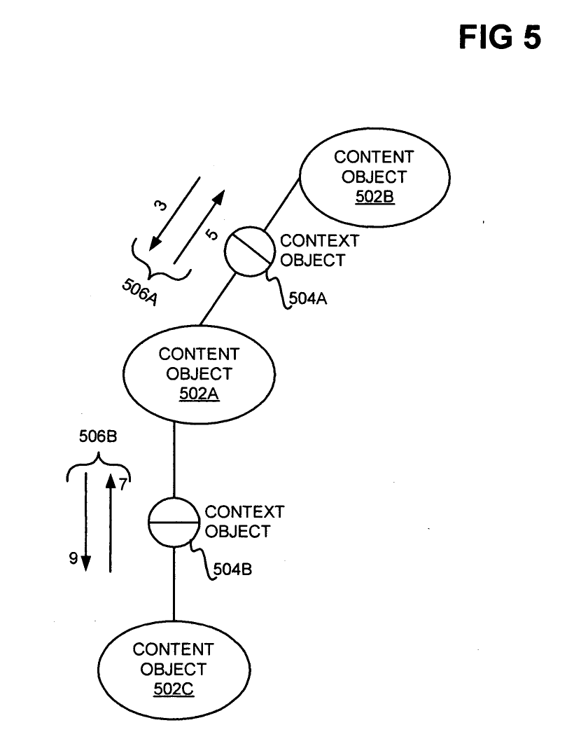

FIG. 5 shows a graphical display of content objects and context objects, according to another embodiment of the invention. The results of a user's keyword search, for instance, may be provided in part 404 in that the “list” of matching content and context objects is provided graphically, as exemplarily depicted in FIG. 5. FIG. 5 specifically shows content objects 502A, 502B, and 502C, collectively referred to as the content objects 502, as well as context objects 504A and 504B, collectively referred to as the context objects 504.

The context object 504A defines the relationship between the content objects 502A and 502B, such as from the content object 502A to the content object 502B, and from the content object 502B to the content object 502A. The arrows 506A indicate the relative strengths of these relationships. Thus, a value of 5 is accorded to the relationship from the object 502A to the object 502B, whereas a value of 3 is accorded to the relationship from the object 502B to the object 502A. That is, it is more likely that the object 502B is related to the object 502A, than the object 502A is related to the object 502B, based upon previous user browsing history.

Likewise, the context object 504B defines the relationship between the content objects 502A and 502C, such as from the content object 502A to the content object 502C, and from the content object 502C to the content object 502A. The arrows 506B indicate the relative strengths of these relationships, as to one another and also as to the relationships defined or represented by the context object 504A. Thus, a value of 7 is accorded to the relationship from the object 502C to the object 502A, whereas a value of 9 is accorded from the object 502A to the object 502C. That is, it is more likely that the object 502C is related to the object 502A, than the object 502A is related to the object 502C, based upon previous user browsing history.

If the user selects any of the content objects 502, then the content object display mechanism 216 displays the details of that content object to the user. In one embodiment, similarly, if the user selects any of the context objects 504, then the context object display mechanism 212 displays the details of that content object to the user. However, in one embodiment, the user may be able to just view displays of a given half of the relationships of one of the context objects 504, depending on which half of a context object the user selects. For example, as depicted in FIG. 5, each of the context objects 504 has two halves, each half being closer to one of the content objects in question. Thus, if the user selects the top half of the context object 504B, then the portion of the context object 504B denoting the relationship from the content object 502A to the content object 502C may be displayed in detail, as opposed to, for instance, the portion denoting the relationship from the object 502C to the object 502A.

Updating Context Objects

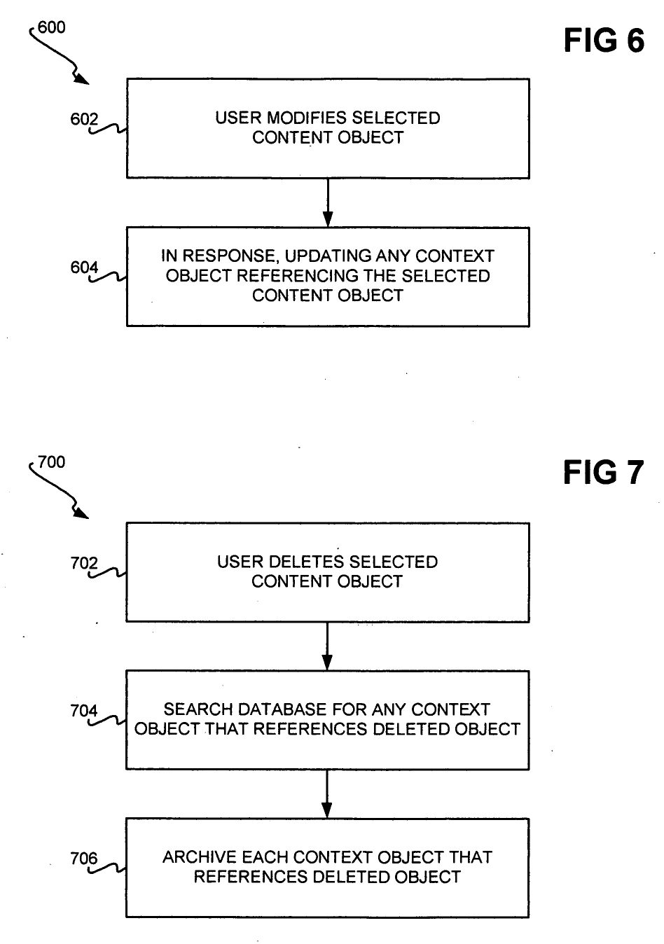

FIG. 6 shows a method 600 for updating a context object, according to an embodiment of the invention. The method 600 may be substantially performed by the context object creation mechanism 214 and/or the log analysis mechanism 220 of the content management system (CMS) 204 of FIG. 2, according to an embodiment of the invention. First, however, a user modifies a selected content object (602). For instance, the user may be operating the client 210 of FIG. 2, and via the access server 206 interacts with the content object creation mechanism 218 to modify the selected content object within the database 224. The user may, for example, change the content of the content object, delete some of the content of this object, or add additional content to the object.

In response, the context object creation mechanism 214 and/or the log analysis mechanism 220 updates any context object that references the selected content object (604). In one embodiment, this includes incrementing, or increasing, each reference counter associated with such a context object, in order to increase the importance of the relationship in question and thus to draw end users' attention to the change that has been made. In another embodiment, updating may include updating the title and other information of the context object, to reflect the newly updated information of the selected content object. Furthermore, in still another embodiment, the user may be allowed to modify some portions of the context object directly, such as by modifying meta data like an automatic deletion data of such an object.

Archiving Context Objects and Conclusion

FIG. 7 shows a method 700 for archiving a context object, according to an embodiment of the invention. The method 700 may be substantially performed by the context object creation mechanism 214 and/or the log analysis mechanism 220 of the content management system (CMS) 204 of FIG. 2, according to an embodiment of the invention. First, however, a user deletes a selected content object (702). For instance, the user may be operating the client 210 of FIG. 2, and via the access server 206 interacts with the content object creation mechanism 218 to delete the selected content object from the database 224.

In response, the mechanism 214 and/or the mechanism 220 searches the database 224 for any context objects that reference the deleted content object (704). Each such found context object is then archived (706). In one embodiment, archival may simply mean the deletion of such a context object itself. In another embodiment, archival may include moving the context object to a different database, or flagging the context object within the database 224 so that it is no longer displayable to the user. For instance, during searching, the search engine 222 will disregard thusly flagged context objects within the database 224.

In addition, other forms of context object deletion are also possible. For example, an administrator, via the client 210, may be able to simply delete a context object from the database 224, via interaction of the access server 206 with the context object creation mechanism 214, for instance, in one embodiment. In another embodiment, a context object may have an “automatic deletion” date, such that once this date has been reached, the context object is automatically deleted. Such automatic deletion may occur during a periodic cleaning, or garbage collection, of the database 224. Furthermore, due to the passage of time, the score(s) of a given context object slowly decrease, or degrade, over time. Once the score(s) drop below the threshold required for context object creation, the reverse occurs as to an already created context object—the context object is deleted. That is, once the score(s) of a given context object drops below this threshold, the context object is deleted, such as during a periodic cleaning or garbage collection of the database 224.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. As such, it is manifestly intended that this invention be limited only by the claims and equivalents thereof.

We claim:

1. A computer-implemented method comprising:
creating a plurality of context objects, each context object representing a relationship from a first content object to a second content object;
storing the context objects within a database in which a plurality of content objects are also stored; and,
permitting a user to simultaneously browse the content objects and the context objects stored within the database.

2. The method of claim 1, wherein creating the context objects comprises, for each context object, comprises:
analyzing a log database for browsing between the first content object and the second content object by a plurality of users to generate one or more statistics regarding the browsing from the first content object to the second content object; and,
where the statistics regarding the browsing from the first content object to the second content object match a predetermined criteria, creating the context object representing the relationship from the first content object to the second content object.

3. The method of claim 2, wherein creating the context objects comprises, for each context object, further comprises initially:
for each of a plurality of users browsing the first content object and the second content object of the context object,
storing browsing status regarding browsing of the user to the first content object, within the log database; and,
storing browsing status regarding browsing of the user to the second content object, such that the user has browsed from the first content object to the second content object, within the log database.

4. The method of claim 2, wherein the statistics regarding the browsing from the first content object to the second content object comprise:
a number of times the second content object has been browsed to after the first content object has been browsed to; and,
a last time the second content object has been browsed to after the first content object has been browsed to.

5. The method of claim 4, wherein the statistics regarding the browsing from the first content object to the second content object further comprises a score determined based on the number of times the second content object has been browsed to after the first content object has been browsed to and the last time the second content object has been browsed to after the first content object has been browsed to.

6. The method of claim 5, wherein the statistics regarding the browsing from the first content object to the second content object match the predetermined criteria where the score determined is greater than a predetermined threshold.

7. The method of claim 1, wherein creating the context objects comprises, for each context object:
each time a selected second content object has been browsed to by each of a plurality of users after a selected first content object has been browsed to by the user, increasing a reference counter associated with browsing from the selected first content object to the selected second content object,
wherein a selected context object is created only after the reference counter is greater than a predetermined threshold, such that the reference counter is further associated with the selected context object.

8. The method of claim 1, further comprising, for a selected content object, updating any context object referencing the selected content object, in response to the selected content object having been modified.

9. The method of claim 8, wherein updating any selected context object referencing the selected content object comprises increasing a reference counter associated with the selected context object.

10. The method of claim 1, wherein permitting the user to simultaneously browse the content objects and the context objects stored within the database comprises:
permitting the user to perform a keyword search on both the content objects and the context objects stored within the database, in a same way as to both the content objects and the context objects; and,
displaying a list of matching content objects and matching context objects as to the keyword search.

11. The method of claim 10, permitting the user to simultaneously browse the content objects and the context objects stored within the database further comprises:
in response to a user selecting one of the matching context objects, determining whether the user has permission to browse the matching context object selected; and,
where the user has permission to browse the matching context object selected, displaying the matching context object selected to the user.

12. The method of claim 1, further comprising, in response to deletion of a selected content object:
searching the database for any context object that references the selected content object; and,
for each context object that references the selected content object, archiving the context object such that the context object is no longer browsable by the user.

13. A computerized system comprising:
a database storing a plurality of content objects and a plurality of context objects, each context object representing a relationship between a first content object and a second content object;
a log database to store information regarding the content objects browsed by a plurality of users within browsing sessions;
a log database analysis mechanism to analyze the log database for browsing between each of a plurality of pairs of content objects to generate one or more statistics regarding browsing from a first content object of each pair of content objects and a second content object of the pair of content objects; and,
a context object-creation mechanism to create the content objects based on the statistics generated by the log database analysis mechanism.

14. The system of claim 13, wherein the context object-creation mechanism is create each context object based on a score determined based on a number of times the second content object of the context object has been browsed to after the first content object of the context object has been browsed to, and a last time the second content object has been browsed to after the first content object has been browsed to.

15. The system of claim 13, wherein the context object-creation mechanism is further to update any context object referencing a selected content object that has been modified.

16. The system of claim 13, wherein the context object-creation mechanism is further to archive any context object referencing a selected content object that has been deleted.

17. The system of claim 13, wherein the database stores each context object in accordance with a data structure comprising:
a title representing the relationship between the first content object and the second content object represented by the context object;
identification of each of the first content object and the second content object, the relationship between which is represented by the context object;
a number of times the first content object has been browsed to after the second content object has been browsed to;
a first score determined at least based on the number of times the first content object has been browsed to after the second content object has been browsed to;
a number of times the second content object has been browsed to after the first content object has been browsed to; and,
a second score determined at least based on the number of times the second content object has been browsed to after the first content object has been browsed to.

18. The system of claim 13, further comprising a context object display mechanism to display a selected context object in response to a request from a user.

19. The system of claim 18, wherein the context object display mechanism is to determine whether the user has permission to browse the selected context object, such that the context object-display mechanism is to display the selected context object only where the user has permission to do so.

20. An article of manufacture comprising:
a tangible computer readable medium; and,
means in the medium for creating a plurality of context objects, each context object representing a relationship from a first content object to a second content object, and for permitting a user to simultaneously browse a plurality of content objects and the plurality of context objects.
